(19) United States
(12) Patent Application Publication
(10) Pub. No.: US 2002/0135331 A1
(43) Pub. Date: Sep. 26, 2002

(54) Force generator

(76) Inventor: Mohammed Mustafa El Shinnawi, Mohaniseen Giza (EG)

Correspondence Address: WILLIAM R. EVANS, LADAS & PARRY, 26 WEST 61st STREET, NEW YORK, NY, 10023, US

(21) Appl. No.: 09/731,239

(22) Filed: Dec. 6, 2000

Related U.S. Application Data
(63) Continuation-in-part of application No. 09/618,748, filed on Jul. 14, 2000, now abandoned.

(30) Foreign Application Priority Data
Jun. 24, 2000 (EG) 808/2000

(51) Int. Cl. H02P 7/00

(52) U.S. Cl. 318/432

(57) ABSTRACT

A device generates a force as the result of centrifugal forces acting on bodies rotated by a motor with an angular velocity around an axle. The direction and magnitude of the force is controllable.

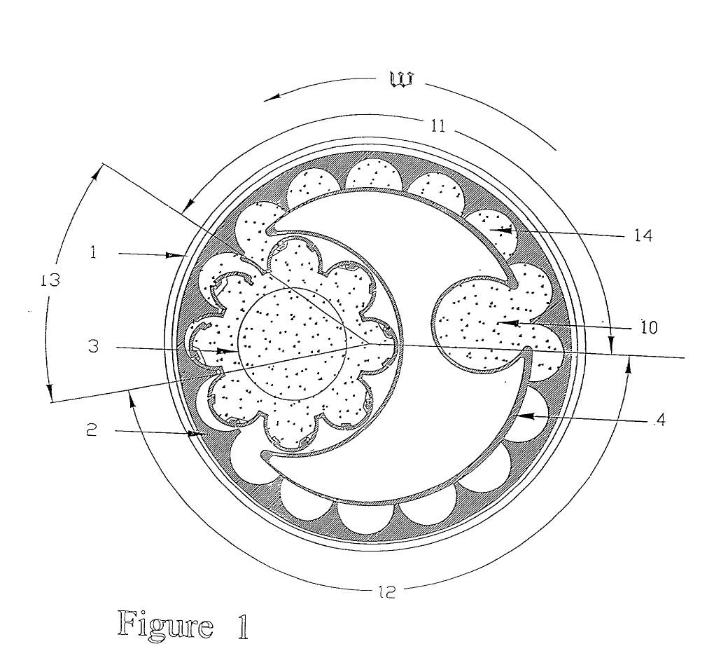

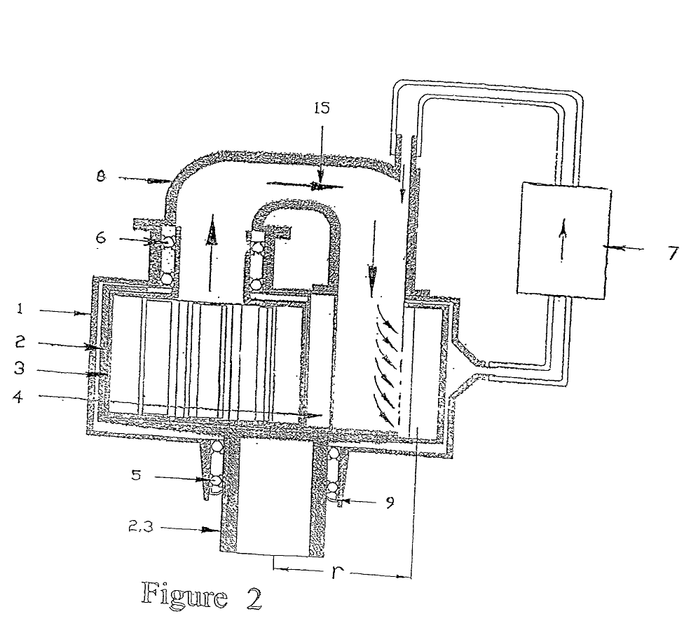

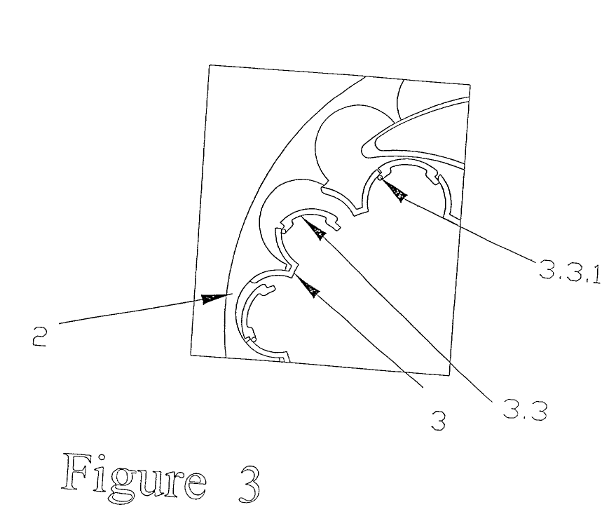

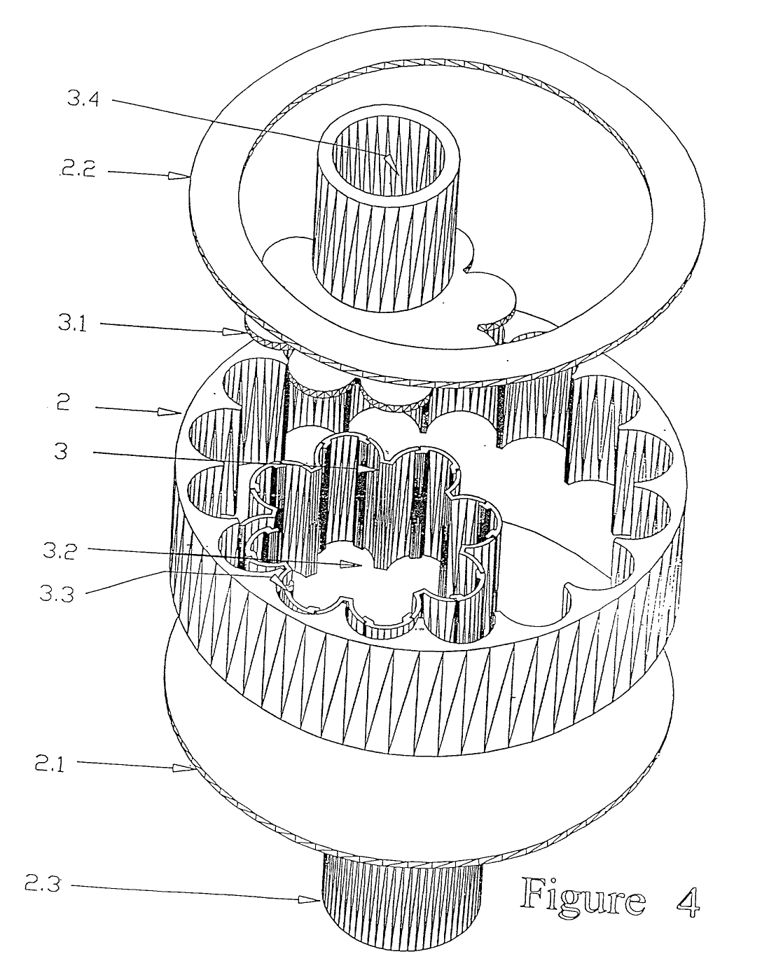

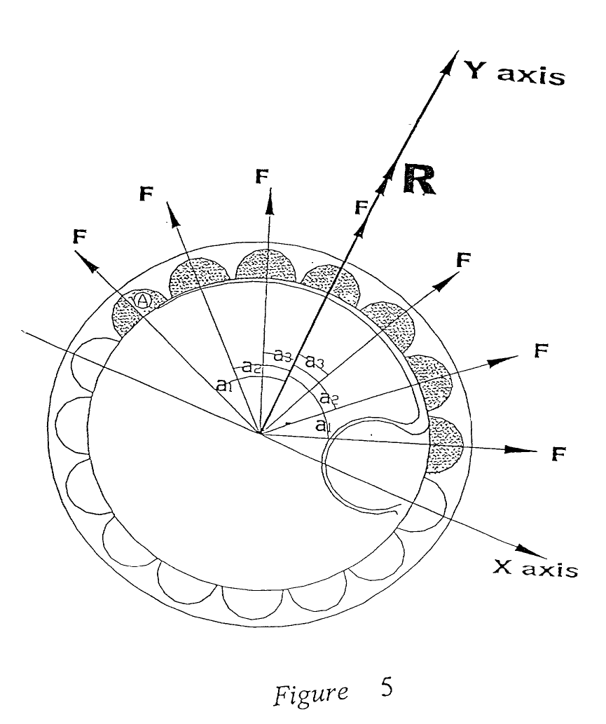

### INTRODUCTION

It is well known that any vehicle needs an engine to generate the required power to move the vehicle. The transmission of power is done merely due to friction between the tires of the vehicle and the ground surface. Also in case of a motor boat or a ship, the steering of the water in an opposite direction to the movement results in the forward sailing of the boat. Even in case of submarines, the propeller generates the force needed.

Same things are to be observed in case of aeroplanes. The air is in this case the sole medium for the fly.

### THE IDEA

The new idea is to use some sort of device that transfers the power generated from an engine into motion not depending on the reaction force with the surrounding medium (ground, water, air or whatsoever).

### THE DEVICE

FIGS. (1), (2), (3), (4), &(5) attached, show sections in the proposed device. It consists mainly of an outer gear (2) that rotates with a constant angular velocity w about its axis (2.3) in the casing (1) through ball-bearing (5). The inner gear (3) meshing with (2) rotates consequently about its axis through the ball-bearing (6). A one-way valve, considered as a gate (3.3), is hinged (3.3.1) to each tooth of the inner gear. Thus the fluid can move in one direction only (From outer gear to inner gear) . In the meshing area between the two gears, the fluid moves from the teeth of the outer gear to the inner one. Then it comes out from the inner gear through its center upward to the U tube (8) to supply the outer gear through position (10). Consequently the teeth of the outer gear leave the meshing area empty of fluid, it will be refilled again when it reaches position (10) a's shown in FIG. (1). As a result to this design, while the outer gear is rotating with a constant angular velocity, almost one half of its teeth will be full, the other half will be empty of fluid. Consequently, centrifugal forces will be generated on each full tooth of the outer gear. A resultant R of all these centrifugal forces may result in the direction shown in FIG. (5)

### HINTS

As it is required to keep the hollow teeth of the outer gear full of liquid, the ring (2.2) shown in FIG. (4) is used. The system is supposed to be a closed circuit for the fluid, Thus the system is supplied with an external hydraulic pump (7) to look after the leaked fluid (it takes the leaked fluid from the casing to supply it back to the device through tube (8) FIG. (2)).

### Applications

For the first time, this device makes it possible to apply the generated force in any direction required by the pilot. In case of a vehicle this generated force R can be adjusted in the forward direction to move the vehicle without applying torque to rotate the car wheels, consequently, no spin on the wheels. Also the generated force R can be applied in the opposite direction of motion to serve as brakes. It is well known that the weight of the vehicle decreases as the velocity increases, in this case, R can applied in a direction to give a component in the direction of gravity, thus giving more weight to the vehicle.

In case of curves, generated force R can be applied towards the center of the curve to minimize the obligatory centrifugal force.

This device can be used also in helicopters, motorboats, and motorcycles.

This device will be as a gift from heaven to submarines, as there will be no need for the propeller, then it will not be easy to be detected from enemies.

### Calculations

IF: m=A×h×δ

Due to rotation of the outer gear with a constant angular velocity Cv. rad 1 sec, an inertia force will be generated on the fluid inside the tooth

F=ω²rm

where r is the distance between the center of rotation of the outer gear and the center of mass of the fluid inside the tooth FIG. (2).

Analysing the forces in the direction of x, y axes we get:

Rₓ=F sin a₁+F sin a₂+F sin a₃+F +F sin a₃+F sin a₂ +F sin a=0

R_{y}=F cos a₁+F cos a₂+F cos a₃+F +F cos a₃+F cos a₂+F cos a₁,

R=resultant of forces=R_{y}

R=F(2 cos a₁+2 cos a₂+2 cos a₃+)

PARTS LIST

| | |
|---|---|
| 1 | Casing |
| 2 | Outer gear |
| 2.1 | Outer gear bottom cover |
| 2.2 | Outer gear ring cover |
| 2.3 | Outer gear axis of rotation |
| 3 | Inner gear |
| 3.1 | Inner gear top cover and its axis of rotation |
| 3.2 | Inner gear bottom cover |
| 3.3 | Valve gate |
| 3.3.1 | Gate hinge |
| 3.4 | Fluid out take |
| 4 | Fluid guide |
| 5 | Ball bearing holding the outer gear |
| 6 | Ball bearing holding the inner gear |
| 7 | Hydraulic pump to return the leaked fluid |
| 8 | U tube to guide the fluid back to outer gear |
| 9 | Oil seal |
| 10 | Fluid intake |
| 11 | Filled teeth region |
| 12 | Empty teeth region |
| 13 | Meshing area between the two gears |
| 14 | Mass of fluid under centrifugal force |
| 15 | Flow direction |

1. Generating an inertia force, which is a resultant to centrifugal forces acting on bodies rotating—by a motor—with an angular velocity around an axis. Through the device, we can control the direction and magnitude of this generated FORCE
